(19) United States
(12) Patent Application Publication
(10) Pub. No.: US 2005/0065912 A1
(43) Pub. Date: Mar. 24, 2005

(54) Digital media system with request-based merging of metadata from multiple databases

(75) Inventors: Charles Cafrelli, Fishers, IN (US); David Lee Stern, Indianapolis, IN (US); F. Matthew Emerson, New Orleans, LA (US)

Correspondence Address: Richard A. Machonkin;McDonnell Boehnen Hulbert & Berghoff, 32nd Floor, 300 S. Wacker Drive, Chicago, IL, 60606, US

(73) Assignee: Digital Networks North America, Inc., Santa Clara, CA (US)

(21) Appl. No.: 10/653,307

(22) Filed: Sep. 2, 2003

(51) Int. Cl. G06F 17/30; G06F 7/00

(52) U.S. Cl. 707/3

(57) ABSTRACT

A digital media system includes a changer control system that controls an optical disc changer. The changer control system includes a local database of metadata records containing information regarding the optical discs in the optical disc changer. The changer control system is also networked to a digital media server that stores digital media files. The digital media server includes a remote database of metadata records containing information regarding the digital media files. The changer control system provides a user interface that allows a user to access information regarding both the optical discs in the optical disc changer and the digital media files stored in the digital media server. To provide this information, a file system of the changer control system creates a merged set of selected metadata records from the local database and the remote database, in response to a request from the user interface.

### BACKGROUND

1. Field of the Invention

This invention relates to a digital media system in which metadata records are stored in multiple databases. More particularly, this invention relates to a digital media system in which a merged set of metadata records from a local database and a remote database is produced in response to a request from a user interface.

2. Description of Related Art

Currently available digital media components provide the user with access to information regarding CDs and/or MP3 in the user's music collection that are available to be played. Such information may include, for example, the artist names, album names, song titles, and other information. This information may be stored in a database in the form of metadata records. A digital media component may include a graphical user interface (GUI) with which the user may interact to access the desired information. The GUI may obtain the information from metadata records stored the database, which may be in the digital media component itself or in another component. Examples of digital media components with such GUIs include Escient' FireBall™ and FireBall™ E-40/E-120 digital music managers and FireBall™ MP-100 digital music player.

When several digital media components are connected together, the overall collection of metadata records may be distributed among multiple databases. This can make the process of accessing the desired information more difficult. Accordingly, there is a need to provide improved approaches for accessing information from a collection of metadata records that is distributed among multiple databases.

### SUMMARY

In a first principal aspect, the present invention provides a method for accessing information from an overall collection of metadata records. The overall collection includes a local database of metadata records and a remote database of metadata records. Each metadata record in the overall collection includes information regarding a particular digital media source. In accordance with the method, in response to user interaction with a user interface, at least one selection criterion is identified for selecting metadata records from which to display information. A candidate set of metadata records is retrieved from the remote database. A remote set of metadata records in the candidate set that satisfy the at least one selection criterion is identified. A local set of metadata records in the local database that satisfy the at least one selection criterion is identified. The remote set and the local set are merged to produce a merged set of metadata records that satisfy the at least one selection criterion. Selected information is displayed from at least one metadata record in the merged set.

In a second principal aspect, the present invention provides a method for accessing information from an overall collection of metadata records. Each metadata record in the overall collection includes information regarding a particular digital media source. The overall collection includes a local database of metadata records and a remote database of metadata records. Each metadata record in the local database is associated with a local record number based on its order in the local database and a collection record number based on its order in the overall collection. Each metadata record in the remote database is associated with a remote record number based on its order in the remote database and a collection record number based on its order in the overall collection. In accordance with the method, in response to user interaction with a user interface, the user interface requests a specified range of N collection record numbers. A sparse map of the remote database is obtained. A candidate set of metadata records is identified based on the sparse map. The candidate set of metadata records is retrieved from the remote database. A remote set of metadata records in the candidate set that have collection record numbers in the specified range is identified. A local set of metadata records in the local database that have collection record numbers in the specified range is identified. The remote set and the local set are merged to produce a merged set of metadata records. The merged set of metadata records is provided to the user interface. The user interface displays selected information from at least one metadata record in the merged set.

In a third principal aspect, the present invention provides a digital media system. The digital media system comprises an optical disc changer, a digital media server, and a changer control system communicatively coupled to the optical disc changer and to the digital media server. The optical disc changer contains a plurality of optical discs. The digital media server stores a plurality of digital media files and includes a remote database of metadata records containing information regarding the digital media files. The changer control system comprises: (a) a local database of metadata records containing information regarding the optical discs in the optical changer; (b) a user interface for allowing a user to access information regarding the optical discs in the optical disc changer and the digital media files stored in the digital media server; and (c) a file system for creating, in response to a request from the user interface, a merged set of metadata records from selected metadata records in the local database and selected metadata records in the remote database.

### BRIEF DESCRIPTION OF THE DRAWINGS

FIG. 1 is simplified block diagram of a digital media system, in accordance with an exemplary embodiment of the present invention;

FIG. 2 is a simplified block diagram of a changer controller, in accordance with an exemplary embodiment of the present invention;

FIG. 3 is a flow chart illustrating the operations of a user interface, in accordance with an exemplary embodiment of the present invention;

FIG. 4 is a screen view of information displayed in a first format by the user interface of FIG. 3, in accordance with an exemplary embodiment of the present invention;

FIG. 5 is a screen view of information displayed in a second format by the user interface of FIG. 3, in accordance with an exemplary embodiment of the present invention;

FIG. 6 is a flow chart illustrating the operations of the user interface of FIG. 3 and a file system, in accordance with an exemplary embodiment of the present invention; and

FIG. 7 is a schematic view of metadata records in a local database, remote database, and the overall collection, in accordance with an exemplary embodiment of the present invention.

### DETAILED DESCRIPTION OF EXEMPLARY EMBODIMENTS

The present invention, in exemplary embodiments, provides a digital media system that allows a user to access information regarding a plurality of digital media sources. As used herein, a “digital media source” means a digital media file, digital media recording, or collection or a source thereof, wherein the term “media” encompasses both audio and video. Thus, a digital media source could be a digital audio file, such as an MP3 file or a WMA file, a collection of digital media files, e.g., a “playlist” of MP3 files, or a source of digital audio files, such as an Internet radio station. Similarly, a digital media source could be a digital video file, such as an MPEG file. A digital media source could also be a digital audio recording, such as a song or an album of songs or other music, or a digital video recording, such as a movie, in a tangible form, such as an optical disc. The optical disc may, for example, be formatted as a compact disc (CD) or digital versatile disc (DVD). The various digital media sources accessible to the digital media system may be stored in different locations. For example, the accessible digital media sources may include a plurality of MP3 files stored in a digital media server, e.g., on a hard drive, and a plurality of optical discs stored in an optical disc changer. Accessible digital media sources may also include digital media files accessible via the Internet, e.g., from streaming media servers such as Internet radio stations.

To provide a user with information regarding the available digital media sources, the digital media system maintains a collection of metadata records. In an exemplary embodiment, each metadata record includes information regarding a particular media source. For example, a metadata record for a CD may include the artist name, the album title, the genre year, label, the names and lengths of the tracks in the album. A metadata record for a CD may also include graphical information, such as a graphic representing the album cover. A metadata record for a video DVD may include the movie title, stars, year, genre, movie length, as well as graphical information, such as a graphic representing the DVD cover. A metadata record for an Internet radio station may include the name of the Internet radio station, the genre of music the station plays, the station's data transfer speed, as well as graphical information, such as a logo of the Internet radio station. A metadata record may also identify a location of the digital media source. The indicated location could be, for example, a hard drive or Internet location for a digital media file or a changer location for a digital media recording.

The collection of metadata records is distributed among multiple databases, e.g., a local database and a remote database. As described in more detail below, the local database may store metadata records containing information regarding digital media sources in certain locations, whereas the remote database may store metadata records containing information regarding digital media sources in other locations. In an exemplary embodiment, the digital media system includes a user interface with which the user can interact. The user interface may display information regarding accessible digital media sources (e.g., artist name, album name, etc.) in response to user interaction. In an exemplary embodiment, the user interface is a graphical user interface (GUI) that displays information in a predetermined graphical format. More particularly, the user interface may display information in the form of a plurality of screens, e.g., a screenful of information at a time. The user may interact with the user interface to navigate through the screens and thereby access desired information.

The user interface may obtain the information it displays from metadata records, which may be stored in either the local database or the remote database. More particularly, the user interface may enable the user to seamlessly access information regarding any of the accessible digital media sources, regardless of whether the metadata records that contain the information are stored in the local database or stored in the remote database.

To accommodate the use of multiple databases to store metadata records, the user interface may request selected metadata records on an “as needed” basis. For example, if the user navigates to a new screen, the user interface may, in response, request those metadata records needed to display information in the new screen, e.g., from a file system. In general, the user interface may provide one or more selection criteria that the file system may use to select the desired metadata records.

The file system may then obtain the metadata records requested by the user interface, i.e., those metadata records in the overall collection that satisfy the one or more selection criteria identified by the user interface. In an exemplary embodiment, the file system identifies a set of metadata records in the local database that satisfy the selection criteria and a set of metadata records in the remote database that satisfy the selection criteria and merges these two sets together. The file system then provides the merged set to the user interface. The user interface may then display information from one or more metadata records, e.g., depending on the user's navigation through the user interface.

In this way, the digital media system need not maintain a unified database that includes the entire collection of metadata records. Instead, the multiple databases may be independently maintained, with selected subsets of the multiple databases merged together as needed to respond to requests from the user interface, i.e., merged “on the fly” or “just in time.”

1. Exemplary Digital Media System

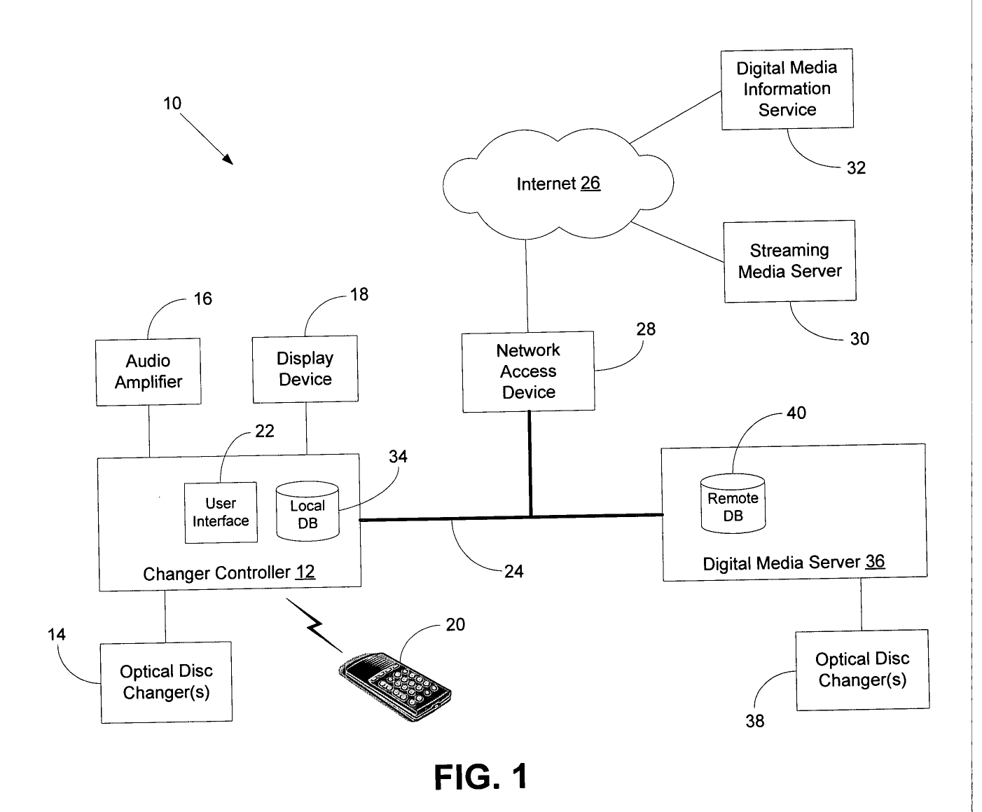

With reference to FIG. 1, an exemplary digital media system 10 may include a changer controller 12 that is communicatively coupled to one or more optical disc changers 14. Optical disc changer(s) 14 may include one or more CD changers and/or one or more DVD changers. Changer controller 12 may control optical disc changer(s) 14, for example, to sense what optical discs are loaded in optical disc changer(s) 14 and to control playback of the optical discs in optical disc changer(s) 14. Changer controller 12 may control optical disc changer(s) 14 via one ore more communication links, such as RS-232 serial ports, S-Link ports, and/or infrared (IR) links. Changer controller 12 may also receive audio signals from optical disc changer(s) 14, e.g., via analog or digital (coaxial or optical SPDIF) inputs, and video signals from optical disc changer(s) 14, e.g., via component video, composite video, or S-video inputs.

Changer controller 12 may also be communicatively coupled to an audio amplifier 16 and to a display device 18. Audio amplifier 16 may be, for example, a stereo system, and may be coupled to one or more speakers. Display device 18 may be a television or other video monitor. Changer controller 12 may be able to direct audio signals to audio system 16, e.g., via analog or digital (coaxial or optical SPDIF) outputs. Changer controller 12 may be able to direct video signals to display device 18, e.g., via component video, composite video, or S-video outputs. Thus, when changer controller 12 is used to control playback of optical discs in optical disc changer(s) 14, changer controller 12 may direct audio signals from optical disc changer(s) 14 to audio amplifier 16 and video signals from optical disc changer(s) 14 to display device 18.

A user input device 20 may be used to control changer controller 12. User input device 20 may, for example, be a remote control device or a keyboard communicatively coupled to changer controller 12 via an IR link. Other input devices could be used, however. For example, display device 18 may include a touch screen that serves as a user input device.

In an exemplary embodiment, changer controller 12 includes a user interface 22 with which a user may interact, e.g., by means of user input device 20. User interface 22 may be a graphical user interface (GUI) that displays information in a predetermined graphical format on display device 18. By using user input device 20, a user may navigate through the GUI, select menu options, and otherwise interact with user interface 22. By interacting with user interface 22, a user may access information regarding digital media sources stored in optical disc changer(s) 14 and in other locations and may control their playback.

Changer controller 12 may also be communicatively coupled to other devices via a network 24. Network 24 may be, for example, an Ethernet network, a Home Phoneline Networking Alliance (HPNA) network, 802.11b wireless network, or HomePlug network. Network 24 may be communicatively coupled to the Internet 26 via a network access device 28. Network access device 28 may be, for example, a cable modem, DSL modem, or dial-up modem. Thus, changer controller 12 may access the Internet 26 via network 14 and network access device 28. Alternatively or additionally, changer controller 12 may include a dial-up modem to access the Internet 26 via the public switched telephone network (PSTN).

Changer controller 12 may access the Internet 26 for a number of different purposes. For example, changer controller 12 may communicate with one or more servers via the Internet 26 for product registration and/or set-up procedures. Changer controller 12 may also access one or more streaming media servers 30 via the Internet 26. Streaming media server(s) 30 are servers that can stream digital media, such as audio and/or video, to changer controller 12, via the Internet 26. Changer controller 12 may, in turn, use audio amplifier 16 and/or display device 18 to render the audio and/or video. Streaming media server(s) 30 may include Internet radio stations, for example.

Changer controller 12 may also be able to access a digital media information service 32, via the Internet 26. Digital media information service 32 provides information regarding digital media sources, such as CDs and DVDs. In particular, changer controller 12 may access digital information service 32 to obtain information regarding the optical discs loaded in optical disc changer(s) 14. For a CD or audio DVD, such information may include, for example, the artist name, the album title, the genre, year, label, the names and lengths of the tracks in the album, and may also include graphical information, such as a graphic representing the album cover. For a video DVD, such information may include, for example, the movie title, stars, year, genre, movie length, as well as graphical information, such as a graphic representing the DVD cover. Escient's OpenGlobe™ service is an example of such a digital media information service. Additional details regarding the process of obtaining information from digital media information service 32 is provided in U.S. Pat. No. 6,304,523, which is incorporated herein by reference.

Changer controller 12 may maintain a local database 34 of metadata records containing information regarding the optical discs loaded in optical disc changer(s) 14. In particular, changer controller 12 may sense when the set of optical discs loaded in optical disc changer(s) 14 changes, e.g., when an optical disc is removed or an optical disc is added, and may update the metadata records in local database 34 accordingly. In an exemplary embodiment, changer controller 12 obtains some or all of the information contained in the metadata records in local database 34 from digital media information service 32. However, some of the information may come from user input, e.g., if digital media information server 32 lacks sufficient information regarding a particular CD or DVD loaded in optical disc changer(s) 14.

Changer controller 12 may be communicatively coupled to a digital media server 36, e.g., via network 24. Digital media server 36 stores digital media files, such as MP3 files, e.g., on an internal hard drive. Digital media server 36 may also be communicatively coupled to one or more optical disc changer(s) 38. Optical disc changer(s) 38 may include, for example, one or more CD changers and/or one or more DVD changers. Escient's FireBall™ and FireBall™ E-40/E-120 digital music managers are examples of such digital media servers.

Digital media server 36 may maintain a remote database 40 of metadata records containing information regarding the digital media sources accessible to digital media server 36, e.g., the digital media files stored in digital media server 36 and the optical discs loaded in optical disc changer(s) 38. Digital media server 36 may obtain this information from digital media information service 32 and/or user input.

Changer controller 12 may communicate with digital media server 36 in order to obtain information regarding the digital media sources accessible to digital media server 36. As described in more detail below, changer controller 12 preferably obtains this information by retrieving selected metadata records from remote database 40, i.e., a subset of remote database 40, on an “as needed” or “just in time” basis. In this way, local database 34 and remote database may be separately maintained by changer controller 12 and digital media server 36, respectively.

Changer controller 12 may also be able to receive digital media from digital media server 36. For example, in response to an appropriate request from changer controller 12, digital media server 36 may stream MP3 files to changer controller 12 via network 24. Changer controller 12 may then play the MP3 files, e.g., using audio amplifier 16 to render the audio. In some embodiments, digital media server 36 may also be able to stream digital audio and/or video to changer controller 12 from optical discs in optical disc changer(s) 38. However, in other embodiments, digital media server 36 may stream only compressed audio files, such as MP3, e.g., because of bandwidth constraints.

Thus, digital media system 10 may include a collection of metadata records, distributed among local database 34 and remote database 40, that contain information regarding all of the digital media sources accessible to digital media system 10, including optical discs loaded in optical disc changer(s) 14, digital media file stored in digital media server 36, and optical discs loaded in optical disc changer(s) 38. Moreover, in an exemplary embodiment, changer controller 12 may be able to access information regarding, and control playback, of these digital media sources, e.g., by controlling optical disc changer(s) 14 or by communicating with digital media server 36.

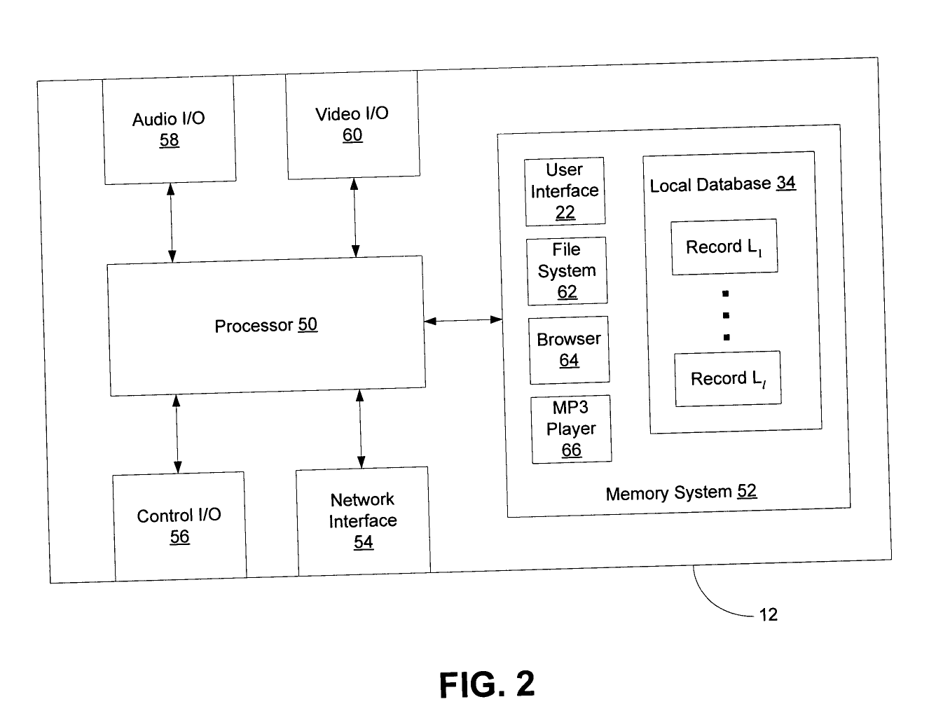

FIG. 2 is a simplified block diagram of changer controller 12, in accordance with an exemplary embodiment. As shown in FIG. 2, changer controller 12 may be controlled by a processor 50 coupled to a memory system 52. Processor 50 may be, for example, an IBM Vulcan processor. Memory system 52 may include various types of volatile and/or non-volatile memory, such as synchronous dynamic random access memory (SDRAM), read only memory (ROM), and/or flash memory.

Processor 50 may also be coupled to a network interface 54, a control input/output block 56, an audio input/output block 58, and a video input/output block 60. Network interface 54 includes components appropriate for interfacing with network 24. For example, network interface 54 may include an Ethernet network interface card with an RJ-45 jack. Network interface 54 may also include a dial-up modem with an RJ-11 jack for connection to the PSTN.

Control I/O block 56 includes components to send and receive control signals, e.g., via RS-232 serial ports, S-Link ports, and/or IR links. Thus, changer controller 12 may be communicatively coupled with optical disc changer(s) 14 and user input device 20 via control I/O block 56.

Audio I/O block 58 includes components to send and receive audio signals, e.g., via analog and/or digital connections (coaxial or optical). Thus, changer controller 12 may be communicatively coupled with optical disc changer(s) 14 and audio amplifier 16 via audio I/O block 58.

Video I/O block 60 includes components to send and receive video signals, e.g., via composite video, component video, and/or S-video connections. Thus, changer controller 12 may be communicatively coupled with optical disc changer(s) 14 and display device 18 via video I/O block 60.

Memory system 52 may store machine language instructions executable by processor 50 to control the operation of changer controller 12. The machine language instructions may be organized into various software modules, including, for example, user interface 22, a file system 62, a browser 64, and an MP3 player 66. Memory system 52 may store other software modules as well.

As described in more detail below, file system 62 may obtain metadata records from local database 34 and remote database 40 in response to queries from user interface 22. Browser 64 may be used to communicate via the Internet 26, e.g., with streaming media server(s) 30 and/or digital media information service 32. MP3 player 66 may be used to play MP3 files, e.g., MP3 files streaming from digital media server 36 via network 24.

Memory system 52 may also store data, including local database 34. Preferably, local database 34 is stored in a non-volatile portion of memory system 52, such as a flash memory. As shown in FIG. 2, local database 34 includes l metadata records, designated L₁ through Lₗ. The designations, L₁ through Lₗ, are consecutive record numbers, with each record number indicating a particular metadata record's order in local database 34, based on a particular ordering method. In an exemplary embodiment, the ordering method is alphabetical based on a “key” consisting of one or more fields in each metadata record. For example, for metadata records relating to music albums, the key could be the artist name followed by the album name. The ordering method would then order the metadata records in alphabetic order by artist name, and, within a particular artist name, alphabetical by album title. Other ordering methods could be used, however.

Thus, each metadata record in local database 34 may include a record number, which indicates its order in local database 34 based on the ordering method, a key (e.g., artist name and album title) on which the ordering method is based, and other information, such track names, track length, genre, cover art, etc. It is to be understood that the record numbers, L₁ through Lₗ, are local database record numbers that relate to the metadata records stored in local database 34. In an exemplary embodiment, the m metadata records stored in remote database 40 are ordered using the same ordering method but are identified by an independent set of remote database record numbers, R₁ through Rₘ.

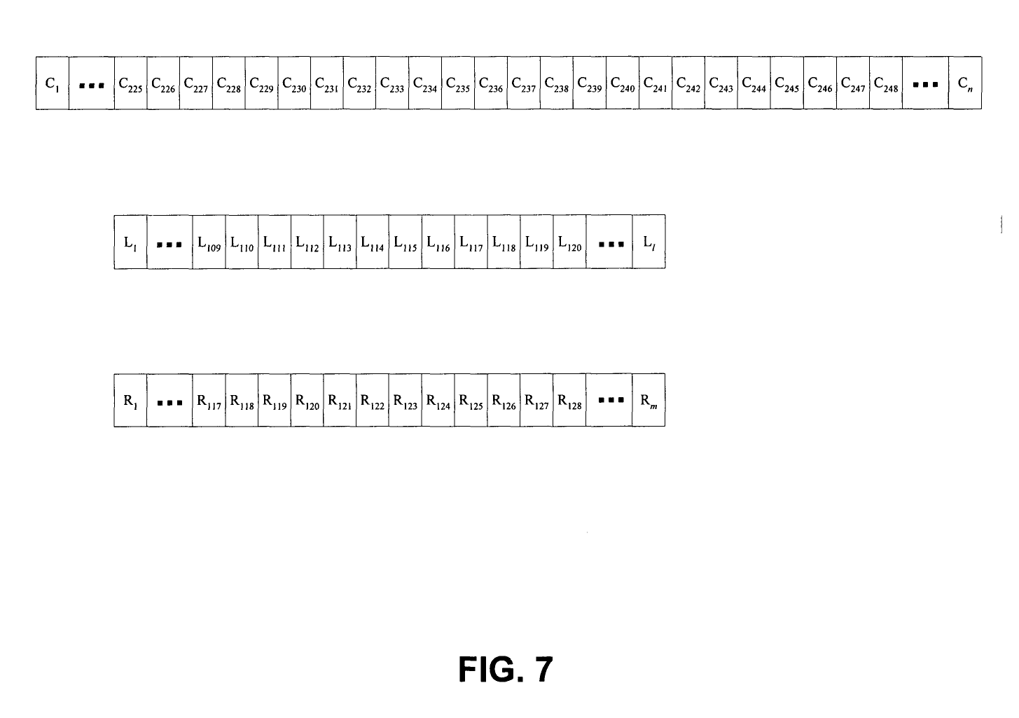

Each metadata record, whether stored in local database 34 or in remote database 40, may also be associated with a collection record number that indicates its order in the overall collection, based on a particular ordering method. Thus, if the overall collection of metadata records in digital media system 10 consists of l metadata records, L₁ through Lₗ, in local database 34 and m metadata records, R₁ through Rₘ, in remote database 40, then the metadata records in the overall collection may be described by the collection numbers, C₁ through Cₙ, where n=l+m. The local database record numbers, L₁ through Lₗ, remote database record numbers, Rₗ through Rₘ, and collection record numbers, C₁ through Cₙ, in this example are illustrated schematically in FIG. 7.

In an exemplary embodiment, each metadata record stored in local database 34 includes its local database record number, and each metadata record stored in remote database 40 may include its remote database record number. However, as stored, a metadata record may not necessarily include its collection record number, because local database 34 and remote database 40 may be independently maintained. Thus, although each metadata record may be associated with a collection record number that indicates its order in the overall collection given a particular ordering method, determining what that collection record number is may require comparisons with other metadata records stored in local database 34 and/or remote database 40, as described in more detail below.

2. Exemplary User Interface

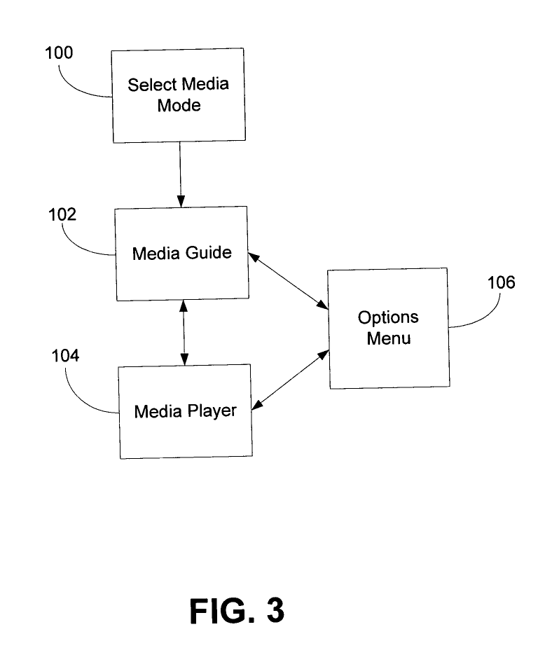

FIG. 3 is a flow chart illustrating the operation of user interface 22, in accordance with an exemplary embodiment. In general, the operation of user interface 22, e.g., the information and options it displays, may depend on what “media mode” user interface 22 is in. In an exemplary embodiment, user interface 22 may include a music mode, in which user interface 22 displays information and options for digital media sources corresponding to music. User interface 22 may also include a movie mode, in which user interface displays information and options for digital media sources corresponding to movies. User interface 22 may also include other media modes, such as a media mode for Internet radio stations.

The user may select a particular media mode, e.g., using user input device 20, for user interface 22, as indicated by block 100. Once a particular media mode is selected, user interface 22 may enter a media guide view, as indicated by block 102. The media guide may comprise one or more screens of information regarding the available digital media sources of a particular type, depending on the media mode of user interface 22. For example, if user interface 22 is in a music mode, then the media guide may display, in a predetermined format, information regarding the CDs stored in optical disc changer(s) 14, the CDs stored in optical disc changer(s) 38, and the MP3 files stored in digital media server 36.

As described in more detail below, the user may navigate through multiple screens of information in the media guide, e.g., using arrow keys on user input device 20.

While in the media guide, the user may enter a media player view, as indicated by block 104. For example, the user may press a “SELECT” or “PLAY” key on user input device 20. The media player may display various options for controlling the playback of a selected digital media source, such as play, stop, pause, fast-forward, or rewind. The user may also be able to return to the media guide view, e.g., by pressing a “GUIDE” key on user input device 20.

While in either media guide view or media player view, the user may enter an options menu, e.g., by pressing an “OPTIONS” key on user input device 20, as indicated by block 106. The options menu may allow the user to perform various organizational or management tasks relating to digital media sources. For example, the user may be able to create or edit playlists or to enter or edit information corresponding to a particular digital media source.

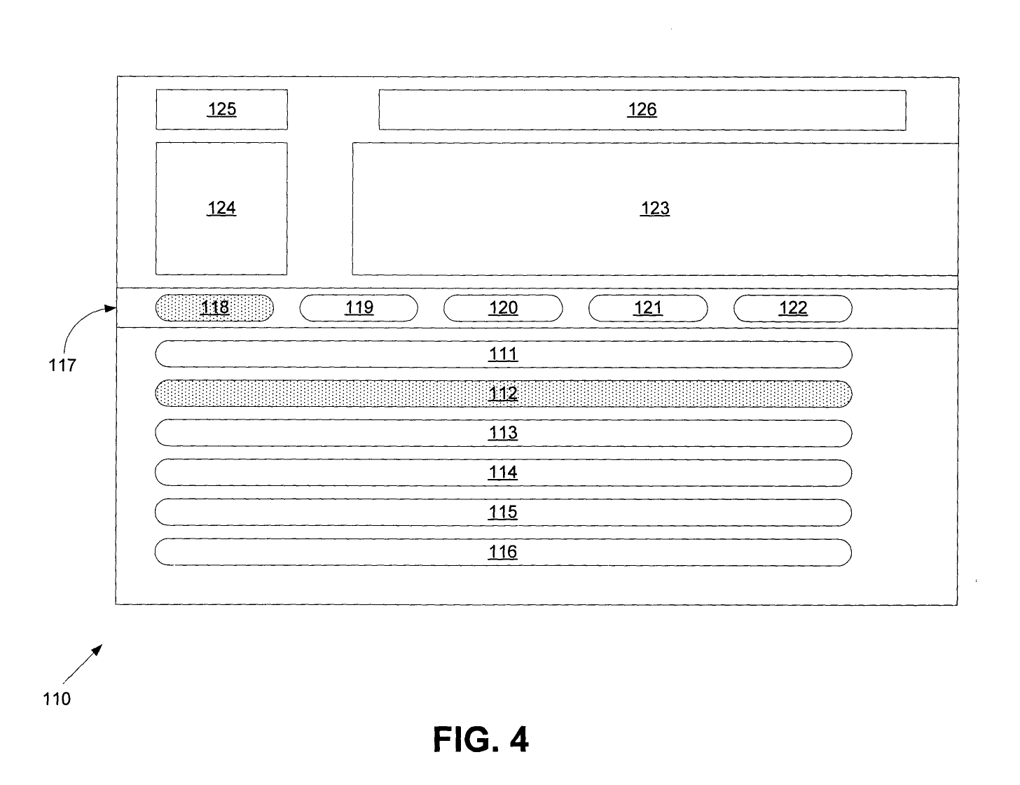

FIG. 4 illustrates an exemplary format for a screenfill of information that user interface 22 may display in the media guide view. In this example, user interface 22 is in the music mode. However, the display may be similar in other media modes. As shown in FIG. 4, screen 110 includes a number of predetermined display areas for displaying information or options. In particular, screen 110 includes six display areas 111-116 for displaying identifications of available digital media sources. Each identification may include, for example, the artist name followed by the album name, and display areas 111-116 may display these identifications in alphabetic order. Each identification may also include an indication of the type of digital media source, e.g., whether it is a CD or an MP3 file. User interface 22 may obtain the information displayed in display areas 111-116 from the metadata records corresponding to these digital media sources.

The user may navigate through display areas 111-116, e.g., using arrow keys on user input device 20. The current navigation point in display areas 111-116 may be indicated, for example, by highlighting. In FIG. 4, display area 112 is highlighted. Screen 110 displays more detailed information regarding the highlighted digital media source, as described in more detail below. The user may also select the highlighted digital media source for playback, in which case user interface 22 may enter the media player view.

When the user navigates above display area 111 or below display area 116, user interface 22 may display identifications for additional digital media sources, e.g., for the next set of digital media sources based on alphabetical order. As described in more detail below, user interface 22 may obtain this additional information by requesting additional metadata records from file system 62.

Screen 110 includes a group bar 117 with group options 118-122. The user may select a group option so that display areas 111-116 display only those digital media sources that meet certain grouping criteria. When group option 118, an “ALL” option, is selected, all digital media sources may be displayed. When group options 119-122 are selected, only certain genres, such as alternative, jazz, pop, and rock, may be displayed. The user may navigate through group options 118-122 and select a particular group option, e.g., using user input device 20.

Screen 110 includes a display area 123 that displays more detailed information regarding the highlighted digital media source in display areas 111-116. Such information may include, for example, the artist name, album title, genre, year, label, and an indication of the location of the digital media source. Screen 110 also includes a display area 124 for displaying a graphic associated with the highlighted digital media source. The graphic may, for example, be cover art that appears on the album cover. User interface 22 may obtain the information displayed in areas 123 and 124 from the metadata record for the highlighted digital media source.

Screen 110 may also include other display areas. For example, screen 110 may include a display area 125 that displays an indication of the media mode, such as “MUSIC” for a music mode, “MOVIE” for a movie mode, or “RADIO” for an Internet radio mode. Screen 110 may also include a display area 126 for displaying advertising.

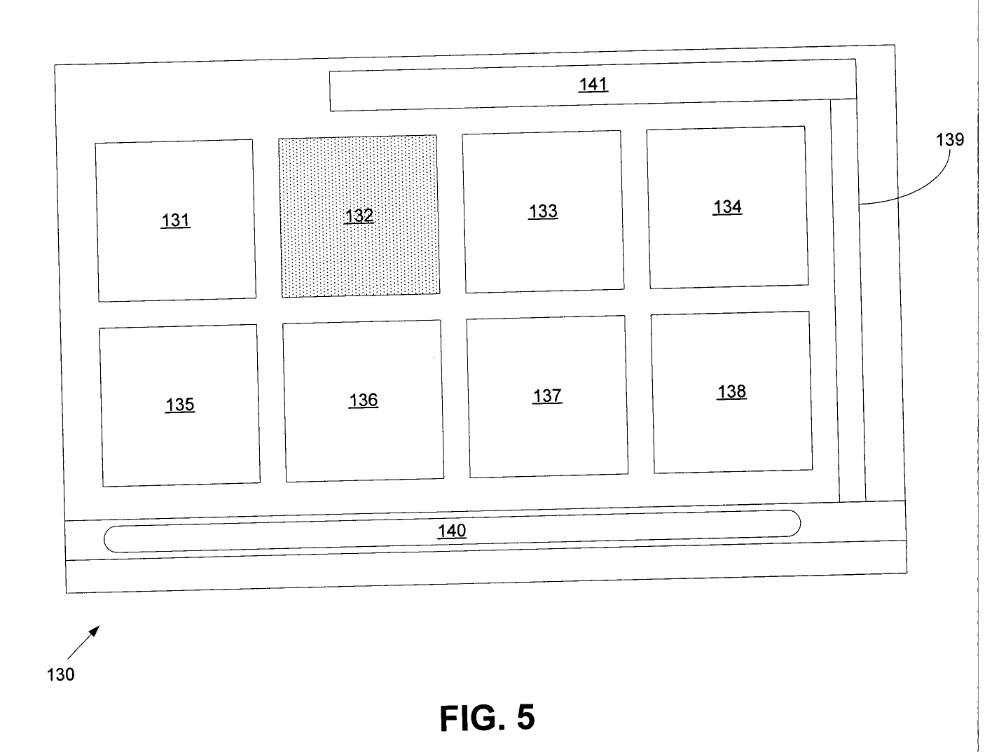

FIG. 5 shows another graphical format that may be used when user interface 22 is in the media guide view. As shown in FIG. 5, screen 130 includes display areas 131-138 that display graphics, e.g., cover art, associated with digital media sources. The graphics may be displayed in display areas 131-138 in a predetermined order, such as alphabetical order by artist name followed by album name. The user may navigate through display areas 131-138, e.g., by using arrow keys on user input device 20 and a scrollbar 139. When the user navigation requires user interface 22 to display graphics for additional digital media sources, user interface 22 may request metadata records for these additional media sources from file system 62, as described in more detail below.

The current navigation point in display areas 131-138 may be indicated by highlighting. For example, display area 132 is highlighted in FIG. 5. Screen 130 includes a display area 140 that displays textual information (e.g., artist name and album title) regarding the highlighted digital media source. The user may also select the highlighted digital media source for playback, in which case user interface 22 enters the media player view. Screen 130 may also include other display areas, such as a display area 141 that displays advertising.

Although FIGS. 4 and 5 illustrate exemplary formats for the display of information and options in the media guide view, other display formats could be used. Moreover, user interface 22 could display other information regarding the digital media sources and display other options for the user than what is shown in FIGS. 4 and 5 and described above.

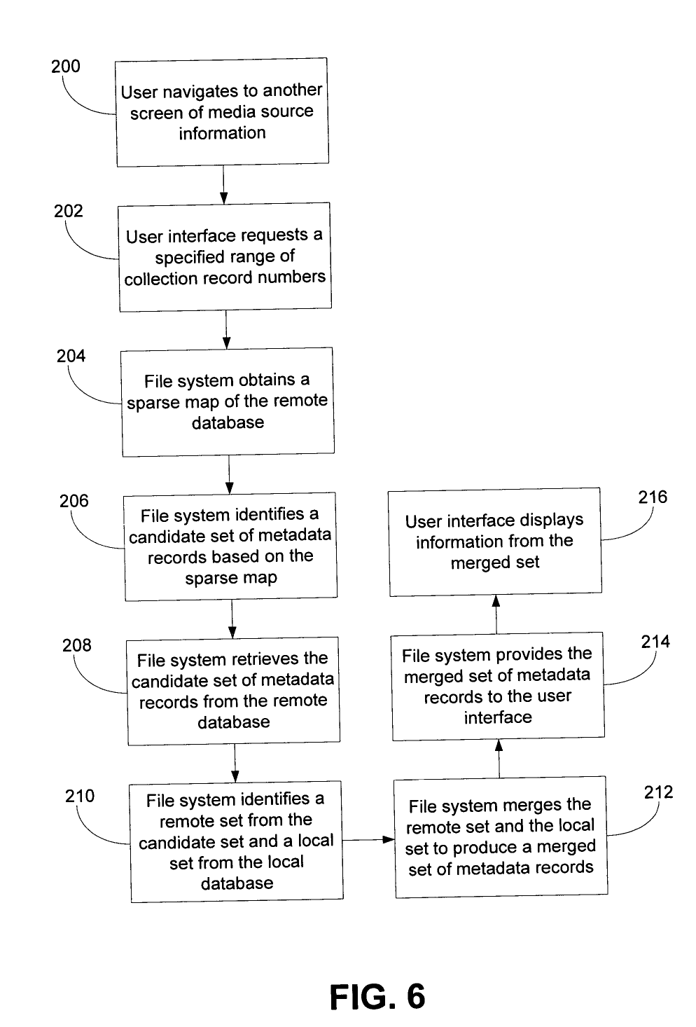

As noted above, user navigation through the media guide view may cause user interface 22 to display information regarding additional digital media resources. To obtain this additional information, user interface 22 may query file system 62 for additional metadata records. FIG. 6 is a flowchart illustrating an exemplary process by which user interface 22 may obtain these additional metadata records from file system 62. As indicated by block 200, the process may begin when the user navigates to another screen of information regarding the available digital media sources (e.g., while in the media guide view).

In response, user interface 22 requests additional metadata records, e.g., by specifying a range of collection numbers, as indicated by block 202. In particular, user interface 22 may display information regarding digital media sources in an order that represents the order of the corresponding metadata records in the overall collection, e.g., based on an ordering method such as alphabetical by artist name followed by album name. Thus, user interface 22 may keep track of what digital media source information it is displaying based on the collection record numbers of the metadata records that contain the information. Then, when the user navigates to another screen of information, it may be convenient for user interface 22 to specify the metadata records needed for the next screen of information in terms of their collection record numbers. Alternatively, user interface 22 may use other selection criteria for specifying which metadata records it is requesting from file system 62.

The number, N, of collection record numbers requested by user interface 22 may be sufficient for an entire screenful of information, for only a partial screenful of information, or for multiple screenfuls of information. In a preferred embodiment, user interface 22 requests metadata records sufficient for several screenfuls of information, e.g., in order to stay ahead of user navigation. Thus, for screen 110, with information from six metadata records in display areas 111-116, or, for screen 130, with graphics from eight metadata records in display areas 131-138, user interface 22 may, for example, request twenty-four (24) metadata records at a time.

FIG. 7 illustrates an example in which user interface 22 requests a range of consecutive collection record numbers, corresponding to a total of twenty-four (24) metadata records, by specifying collection record number 225 as the beginning of the range and collection record number 248 as the end of the range. In this example, this range of collection record numbers, C₂₂₅ through C₂₄₈, corresponds to metadata records in local database 34, with local database record numbers, L₁₀₉ through L₁₂₀, and to metadata records in remote database 40, with remote database record numbers, R₁₁₇ through R₁₂₈, as illustrated in FIG. 7. However, file system 62 may not already have this correspondence between collection record numbers, local database record numbers, and remote database record numbers, when file system 62 receives the request from user interface 22. Thus, file system 62 may need to determine which metadata records in local database 34 and remote database 40 fall within the range of collection record numbers requested by user interface 22.

File system 62 may use a number of different approaches to make this determination. In one approach, file system 62 begins by obtaining a sparse map of remote database 40, as indicated by block 204. To obtain the sparse map, file system 62 may retrieve every S^{th} remote database record number from remote database 20, storing the retrieved metadata records in memory system 52. For purposes of efficiency, S is preferably greater than N. Since N is twenty-four (24) in this example, S may be fifty (50). Thus, file system 62 may retrieve the metadata records identified by remote database numbers R₁, R₅₁, R₁₀₁, etc., in this example.

The metadata records in the sparse map may serve as reference points in remote database 40 and in the overall collection. To determine the collection record number of a particular metadata record in the sparse map, file system 62 may query local database 34 by key for the record immediately preceding the key in the particular metadata record. In an exemplary embodiment, the key is artist name followed by album name. Thus, if metadata record R₁₀₁ in the sparse map has “Beatles, Hard Days Night” as its key, the immediately preceding key in local database 34 may be “Beatles, Abbey Road,” with local database record number L₁₀₇. The collection record number for this particular metadata record in the sparse map, then, is the sum of its remote database record number and this local database record number. Thus, file system 62 is able to infer that metadata record R₁₀₁ in remote database 40 is metadata record C₂₀₈ in the overall collection, based on this ordering method.

Based on the sparse map, file system 62 may then identify a candidate set of metadata records in remote database 40, as indicated by block 206. In particular, file system 62 may determine which metadata record in the sparse map has a collection record number that is the greatest lower bound (GLB) of the starting collection record number in the range specified by user interface 22, e.g., using the collection record number determination method described above in a binary search procedure. Thus, in this example, file system 62 would identify metadata record R₁₀₁ as the GLB in the sparse map. File system 62 may then identify the candidate set as the S+N metadata records in remote database 40 beginning with the GLB record, i.e., beginning with R₁₀₁. This number of metadata records is chosen so that the candidate set can be expected to include all N metadata records requested by user interface 22, given the coarseness of the sparse map.

File system 62 retrieves the candidate set from remote database 40, storing the retrieved metadata records in memory system 52, as indicated by block 208. File system 62 then identifies those metadata records in the candidate set that fall within the specified range as a “remote set” of metadata records for the merge and identifies those metadata records in local database 34 that fall within the specified range as a “local set” of metadata records for the merge, as indicated by block 210. In particular, file system 62 may determine the metadata record in the candidate set that has a collection record number that is the true GLB of the starting collection record number, C₂₂₅, e.g., using the collection record number determination method described above in a binary search procedure.

The true GLB metadata record may have a collection record number that corresponds to the starting collection record specified by user interface 22, i.e., C₂₂₅, in this example. In that case, the true GLB is also the first metadata record in the remote set within the candidate set, and the metadata record in local database 34 that has the next key after the key in the true GLB is the first metadata record in the local set. Alternatively, the true GLB metadata record may have a collection record number that is less than the starting collection record number specified by user interface 22. In that case, the metadata record in the candidate set that immediately follows the true GLB is the first metadata record in the remote set. In addition, the starting collection record number corresponds to a metadata record in local database 34, which metadata record is also the first in the local set. This metadata record in local database 34 may be determined based on (i) the location in local database 34 of the metadata record that has the next key after the key in the true GLB and (ii) the difference between the true GLB's collection record number and the starting collection record number requested by user interface 22. In this way, file system 62 may determine the starting point of the remote set in the candidate set retrieved from remote database 40 and the starting point of the local set in local database 34. File system 62 may identify the rest of the remote set and local set by determining the collection record numbers of successive metadata records in local database 34 and/or in the candidate set until the ending collection record number requested by user interface 22, i.e., C₂₄₈ in this example, is reached.

File system 62 then merges the remote set and the local set to produce a merged set of metadata records, as indicated by block 212. Thus, the merged set consists of N metadata records from local database 34 and remote database 40 that have collection record numbers spanning the range specified by user interface 22, ordered based on a particular ordering method such as alphabetical by artist name followed by album name. In this example, the merged set consists of metadata records, C₂₂₅ through C₂₄₈, and is made from metadata records, L₁₀₉ through L₁₂₀, from local database 34 and metadata records, R₁₁₇ through R₁₂₈, from remote database 40.

File system 62 then provides the merged set of metadata records to user interface 22, as indicated by block 214. User interface 22, in turn, displays information from one or more metadata records in this merged set, e.g., to display another screenful of information in the media guide, as indicated by block 216.

In this way, changer controller 12 need not maintain all of the metadata records in the overall collection. Instead, the metadata records in the collection may be distributed among multiple, independently-maintained databases, with selected metadata records in the overall collection being retrieved and placed in a merged set on an “as needed” basis, e.g., in response to user navigation through user interface 22. This “as needed,” “on the fly,” or “just in time” approach can reduce the memory requirements of changer controller 12 because, at any given time, changer controller 12 may store only a subset of the overall collection of metadata records. This approach can also reduce the time it takes to update the collection of metadata records in response to changes in the available digital media sources, e.g., the addition or removal of optical discs from optical disc changer(s) 14, because only a part of the overall collection would need to be updated.

3. Conclusion

Exemplary embodiments of the present invention have been described above. Those skilled in the art will understand, however, that changes and modifications may be made to these embodiments without departing from the true scope and spirit of the invention, which is defined by the claims.

1. A method for accessing information from an overall collection of metadata records, wherein the overall collection includes a local database of metadata records and a remote database of metadata records, and wherein each metadata record in the overall collection includes information regarding a particular digital media source, the method comprising:
in response to user interaction with a user interface, identifying at least one selection criterion for selecting metadata records from which to display information;
retrieving a candidate set of metadata records from the remote database;
identifying a remote set of metadata records in the candidate set that satisfy the at least one selection criterion;
identifying a local set of metadata records in the local database that satisfy the at least one selection criterion;
merging the remote set and the local set to produce a merged set of metadata records that satisfy the at least one selection criterion; and
displaying selected information from at least one metadata record in the merged set.

2. The method of claim 1, wherein displaying selected information from at least one metadata record in the merged set comprises:
displaying at least one artist name.

3. The method of claim 1, wherein displaying selected information from at least one metadata record in the merged set comprises:
displaying at least one album title.

4. The method of claim 1, wherein displaying selected information from at least one metadata record in the merged set comprises:
displaying at least one playlist title.

5. The method of claim 1, wherein displaying selected information from at least one metadata record in the merged set comprises:
displaying at least one movie title.

6. The method of claim 1, wherein displaying selected information from at least one metadata record in the merged set comprises:
displaying at least one track name.

7. The method of claim 1, wherein displaying selected information from at least one metadata record in the merged set comprises:
displaying at least one cover graphic.

8. The method of claim 1, wherein the at least one selection criterion selects metadata records that fall within a consecutive range in the overall collection based on a predetermined ordering method.

9. The method of claim 8, wherein the predetermined ordering method specifies alphabetic ordering based on artist name followed by album name.

10. The method of claim 8, further comprising:
obtaining a sparse map of the remote database; and
identifying the candidate set based on the sparse map.

11. A method for accessing information from an overall collection of metadata records, wherein each metadata record in the overall collection includes information regarding a particular digital media source, and wherein the overall collection including a local database of metadata records and a remote database of metadata records, each metadata record in the local database being associated with a local record number based on its order in the local database and a collection record number based on its order in the overall collection, each metadata record in the remote database being associated with a remote record number based on its order in the remote database and a collection record number based on its order in the overall collection, the method comprising:
in response to user interaction with a user interface, the user interface requesting a specified range of N collection record numbers;
obtaining a sparse map of the remote database;
identifying a candidate set of metadata records based on the sparse map;
retrieving the candidate set of metadata records from the remote database;
identifying a remote set of metadata records in the candidate set that have collection record numbers in the specified range;
identifying a local set of metadata records in the local database that have collection record numbers in the specified range;
merging the remote set and the local set to produce a merged set of metadata records;
providing the merged set of metadata records to the user interface;
the user interface displaying selected information from at least one metadata record in the merged set.

12. The method of claim 11, wherein displaying selected information from at least one metadata record in the merged set comprises:
displaying at least one artist name.

13. The method of claim 1, wherein displaying selected information from at least one metadata record in the merged set comprises:
displaying at least one album title.

14. The method of claim 11, wherein displaying selected information from at least one metadata record in the merged set comprises:
displaying at least one playlist title.

15. The method of claim 11, wherein displaying selected information from at least one metadata record in the merged set comprises:
displaying at least one movie title.

16. The method of claim 11, wherein displaying selected information from at least one metadata record in the merged set comprises:
displaying at least one track name.

17. The method of claim 1, wherein displaying selected information from at least one metadata record in the merged set comprises:
displaying at least one cover graphic.

18. The method of claim 1, wherein obtaining a sparse map comprises:
retrieving every S^{th} metadata record in the remote database to obtain a sparse set of metadata records.

19. The method of claim 18, wherein identifying a candidate set of metadata records based on the sparse map comprises:
identifying a greatest lower bound metadata record in the sparse set by identifying which metadata record in the sparse set has the highest collection record number that does not exceed the lowest collection record number in the specified range; and
identifying a set of N+S consecutive remote record numbers, beginning with the remote record number of the greatest lower bound metadata record.

20. A digital media system, comprising:
an optical disc changer containing a plurality of optical discs;
a digital media server, wherein the digital media server stores a plurality of digital media files and includes a remote database of metadata records containing information regarding the digital media files; and
a changer control system communicatively coupled to the optical disc changer and to the digital media server, wherein the changer control system comprises:
(a) a local database of metadata records containing information regarding the optical discs in the optical disc changer;
(b) a user interface for allowing a user to access information regarding the optical discs in the optical disc changer and the digital media files stored in the digital media server; and
(c) a file system for creating, in response to a request from the user interface, a merged set of metadata records from selected metadata records in the local database and selected metadata records in the remote database.

21. The digital media system of claim 20, wherein the optical disc changer is a compact disc (CD) changer containing a plurality of CDs.

22. The digital media system of claim 20, wherein the optical disc changer is a digital versatile disc (DVD) changer containing a plurality of audio DVDs.

23. The digital media system of claim 20, wherein the optical disc changer is a digital versatile disc (DVD) changer containing a plurality of video DVDs.

24. The digital media system of claim 20, wherein the digital media server stores a plurality of MP3 files.

25. The digital media system of claim 20, wherein the changer control system further comprises an MP3 player.

26. The digital media system of claim 20, further comprising a user input device communicatively coupled to the changer control system.

27. The digital media system of claim 20, further comprising an audio amplifier communicatively coupled to the changer control system.

28. The digital media system of claim 20, further comprising a display device communicatively coupled to the changer control system.

29. The digital media system of claim 28, wherein the user interface displays on the display device selected information from at least one metadata record in the merged set.
